(19) United States
(12) Patent Application Publication
(10) Pub. No.: US 2022/0035050 A1
(43) Pub. Date: Feb. 3, 2022

(54) SERVER, NON-TRANSITORY COMPUTER READABLE MEDIUM, COMMUNICATION APPARATUS, AND VEHICLE

(71) Applicant: Toyota Jidosha Kabushiki Kaisha, Toyota-shi Aichi-ken (JP)

(72) Inventors: Yusuke Nakade, Nagoya-shi (JP); Miho Otsuka, Nagoya-shi (JP); Hirokazu Kano, Nagoya-shi (JP); Evan Vijithakumara, Frisco, TX (US)

(21) Appl. No.: 17/380,668

(22) Filed: Jul. 20, 2021

(30) Foreign Application Priority Data
Aug. 3, 2020 (JP) 2020-132034

(51) Int. Cl. G01S 19/46; G01S 19/51; G01S 19/39; G01S 19/40

(52) U.S. Cl. CPC G01S 19/46; G01S 19/40; G01S 19/393; G01S 19/51

(57) ABSTRACT

A server according to the present disclosure includes a communication interface and a controller. The controller receives, from a vehicle via the communication interface, received-radio-wave information indicating a state of a radio wave wirelessly received by the vehicle, and determines a position of the vehicle based on the received-radio-wave information using association information associating one or more positions with states of respective radio waves received at the one or more positions.

### CROSS-REFERENCE TO RELATED APPLICATION

This application claims priority to Japanese Patent Application No. 2020-132034, filed on Aug. 3, 2020, the entire contents of which are incorporated herein by reference.

### TECHNICAL FIELD

The present disclosure relates to a server, a program, a communication apparatus, and a vehicle.

### BACKGROUND

Technology for determining the positions of vehicles is known. For example, Patent Literature (PTL) 1 discloses a position-detecting device capable of detecting the position of a vehicle by using information on a point at which a radio wave transmitted from a base station is disrupted.

### CITATION LIST

### Patent Literature

PTL 1: JP 2008-039688 A

### SUMMARY

In recent years, there has been a need to further improve the utility of technology for determining positions of vehicles. For example, when a vehicle travels while wirelessly receiving a radio wave, the state of the radio wave wirelessly received by the vehicle may render features unique to a position of the vehicle depending on the position, or the materials or shapes of buildings around the vehicle. Therefore, it is required to determine the positions of vehicles, based on the state of a radio wave wirelessly received by the vehicle.

It would be helpful to provide a server, a program, a communication apparatus, and a vehicle that improve the utility of technology for determining the positions of vehicles.

A server according to an embodiment of the present disclosure includes:

a communication interface; and

a controller configured to receive, from a vehicle via the communication interface, received-radio-wave information indicating a state of a radio wave wirelessly received by the vehicle, and determine a position of the vehicle based on the received-radio-wave information using association information associating one or more positions with states of respective radio waves received at the one or more positions.

A program according to an embodiment of the present disclosure is configured to cause a computer to function as a server, the server including:

a communication interface; and

a controller configured to receive, from a vehicle via the communication interface, received-radio-wave information indicating a state of a radio wave wirelessly received by the vehicle, and determine a position of the vehicle based on the received-radio-wave information using association information associating one or more positions with states of respective radio waves received at the one or more positions.

A communication apparatus according to an embodiment of the present disclosure is a communication apparatus included in a vehicle, the communication apparatus including:

a communication interface; and

a controller configured to transmit, to a server via the communication interface, received-radio-wave information indicating a state of a radio wave wirelessly received by the vehicle, and cause the server to determine a position of the vehicle based on the received-radio-wave information using association information associating one or more positions with states of respective radio waves received at the one or more positions.

A vehicle according to an embodiment of the present disclosure includes the communication apparatus.

A server, a program, a communication apparatus, and a vehicle according to an embodiment of the present disclosure improve the utility of technology for determining the positions of vehicles.

### BRIEF DESCRIPTION OF THE DRAWINGS

In the accompanying drawings:

FIG. 1 is a diagram illustrating a schematic configuration of an information processing system according to an embodiment of the present disclosure;

FIG. 2 is a block diagram illustrating a configuration of a vehicle according to an embodiment;

FIG. 3 is a block diagram illustrating a configuration of a server according to an embodiment;

FIG. 4 is a flowchart illustrating operations of the information processing system according to an embodiment;

FIG. 5 is a flowchart illustrating operations of the information processing system, following those of FIG. 4;

FIG. 6 is a schematic diagram illustrating positions of the vehicle in an example; and

FIG. 7 is a diagram illustrating time series change in intensity of a radio wave received by the vehicle illustrated in FIG. 6.

### DETAILED DESCRIPTION

Hereinafter, an embodiment of the present disclosure will be described.

In the drawings, the same or corresponding portions are denoted by the same reference numerals. In the descriptions of the present embodiment, detailed descriptions of the same or corresponding portions are omitted or simplified, as appropriate.

(Configuration of Information Processing System)

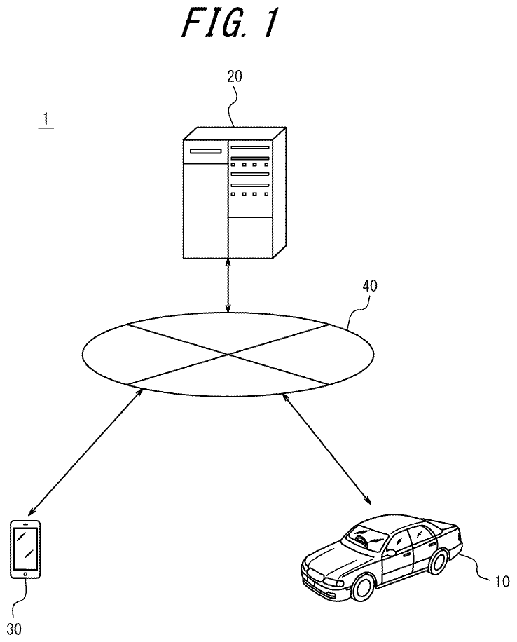

With reference to FIG. 1, an outline of the information processing system 1 according to the present embodiment will be described. FIG. 1 is a diagram illustrating a schematic configuration of the information processing system 1. The information processing system 1 includes a vehicle 10, a server 20, and a terminal apparatus 30. FIG. 1 illustrates one each of the vehicle 10, the server 20, and the terminal apparatus 30. However, the information processing system 1 may include any number of vehicles 10, servers 20, and terminal apparatuses 30.

The vehicle 10 is, for example, an automobile. However, the vehicle 10 is not limited to an automobile, and may be any vehicle such as a motorcycle or a bicycle. The vehicle 10 may be driven by a driver, or driving may be automated at any level. The level of automation is, for example, one of level 1 to level 5 in the level classification of the Society of Automotive Engineers (SAE).

The server 20 is configured by one or more computers. In the present embodiment, the server 20 will be described as being configured by a single computer. However, the server 20 may be configured by multiple computers, such as a cloud computing system.

Examples of the terminal apparatus 30 include a mobile phone, a smartphone, and a computer such as a personal computer. In this specification, a computer is also referred to as an information processing apparatus. In the present embodiment, the terminal apparatus 30 is used, for example, by a user of the vehicle 10.

The terminal apparatus 30 is used by a user of a vehicle 10 to check the position of the vehicle 10. The terminal apparatus 30 communicates with the server 20 to receive an instruction to display the position of the vehicle 10 from the server 20. The terminal apparatus 30 displays, for example, on a display, the position of the vehicle 10 on a map, based on an instruction received from the server 20 to display the position of the vehicle 10.

The network 40 is any communication network through which the vehicle 10, the server 20, and the terminal apparatus 30 can communicate with one another. For example, the network 40 in the present embodiment may include an ad hoc network, a Metropolitan Area Network (MAN), a cellular network, a Wireless Personal Area Network (WPAN), the Public Switched Telephone Network (PSTN), a Terrestrial Wireless Network, an optical network or another type of network, or a combination of any of these.

The information processing system 1 is used for a service of providing a user with positional information for the vehicle 10. “Positional information” for a vehicle 10 is information indicating the position of the vehicle 10 at a certain time point.

When a vehicle 10 travels while wirelessly receiving a radio wave, the state of the radio wave wirelessly received by the vehicle 10 may render features unique to a position of the vehicle depending on the position, or the materials, shapes, or the like of buildings around the vehicle 10. The state of the radio wave includes, for example, a time series change in intensity of the radio wave. As an example, when the vehicle 10 enters a tunnel, a multi-story parking lot, a building, an underground road, or the like while traveling, a radio wave to be wirelessly received from outside by the vehicle 10 may be shielded and attenuated by a shielding object such as a wall or a ceiling. Meanwhile, when the vehicle 10 comes out of the tunnel, the multi-story parking lot, the building, the underground road, or the like while traveling, the shielding object is eliminated and thus a radio wave wirelessly received from outside by the vehicle 10 may no longer be attenuated. Such increases or decreases in the intensity of the radio wave render features that differ depending on the position, material, or shape of the shielding object. Accordingly, the position of a vehicle 10 can be determined based on the state of a radio wave wirelessly received by the vehicle 10.

In the information processing system 1, the server 20 communicates with the vehicle 10 to receive, from the vehicle 10, received-radio-wave information that indicates the state of a radio wave wirelessly received by the vehicle 10. The server 20 can determine a position of the vehicle 10 based on the received-radio-wave information using association information associating one or more positions with states of respective radio waves received at the one or more positions. Therefore, the information processing system 1 improves the utility of technology for determining the position of the vehicle 10.

Next, the vehicle 10 and the server 20 in the information processing system 1 will be described in detail.

(Configuration of Vehicle)

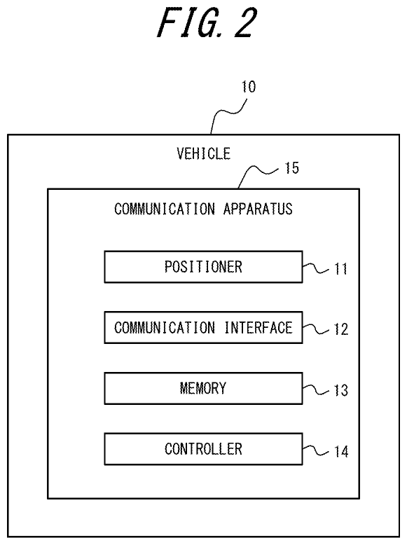

With reference to FIG. 2, a configuration of the vehicle 10 according to the present embodiment will be described. FIG. 2 is a block diagram illustrating the configuration of the vehicle 10. As illustrated in FIG. 2, the vehicle 10 includes a positioner 11, a communication interface 12, a memory 13, and a controller 14. The positioner 11, the communication interface 12, the memory 13, and the controller 14 are connected to one another, via an in-vehicle network such as a Controller Area Network (CAN) or dedicated lines so as to be able to communicate with one another by wire or wirelessly.

In the present embodiment, the communication apparatus 15 included in the vehicle 10 is described as having all the functions of the positioner 11, the communication interface 12, the memory 13, and the controller 14. The communication apparatus 15 is, for example, an in-vehicle apparatus such as an Electronic Control Unit (ECU), a car navigation apparatus, or an in-vehicle communication device. Alternatively, the communication apparatus 15 may be a mobile phone, a smartphone, or a computer such as a personal computer, installed on the vehicle 10. However, some of the functions described above may be provided by another in-vehicle apparatus mounted in the vehicle 10 that is communicably connected to the communication apparatus 15.

The positioner 11 measures a position of the vehicle 10, and generates positional information for the vehicle 10. As described above, the positional information for a vehicle 10 is information indicating the position of the vehicle 10 at a certain time point. The positional information for a vehicle 10 includes information indicating the time point and information indicating the position of the vehicle 10. The information indicating the time point is, for example, a date or a time. The information that indicates the position is, for example, coordinates such as two-dimensional coordinates or three-dimensional coordinates. For example, a car navigation apparatus included in the vehicle 10 may function as the positioner 11.

In the present embodiment, the positioner 11 can measure the position of the vehicle 10 through navigation using a satellite positioning system. The positioner 11 includes a receiver corresponding to the satellite positioning system for measuring the position of the vehicle 10 through navigation using the satellite positioning system. The satellite positioning system which the receiver corresponds to may be, for example, the Global Positioning System (GPS). The positioner 11 receives, via the receiver, radio waves from a plurality of artificial satellites (for example, three artificial satellites) for navigation using a satellite positioning system. The positioner 11 may also measure the position of the vehicle 10 by a combination of navigation using a satellite positioning system and autonomous navigation. The positioner 11 includes a sensor such as an acceleration sensor or a gyro sensor, for measuring the position of the vehicle 10 by autonomous navigation. This configuration enables the positioner 11 to measure the position of the vehicle 10 mainly through navigation using the satellite positioning system, and when the vehicle 10 is traveling underground, in a tunnel, or the like, and thus cannot receive a radio wave from a satellite positioning system, the positioner 11 can measure the position of the vehicle 10 by autonomous navigation.

The communication interface 12 includes a communication module for connecting to the network 40. The communication module is, for example, a communication module compliant with a mobile communication standard such as the 4th Generation (4G) standard or the 5th Generation (5G) standard. The communication module may be, for example, a communication module compliant with a standard such as a wired Local Area Network (LAN) standard or a wireless LAN standard. The communication module may be a communication module compliant with a short-range wireless communication standard such as Wi-Fi® (Wi-Fi is a registered trademark in Japan, other countries, or both), Bluetooth® (Bluetooth is a registered trademark in Japan, other countries, or both), or an infrared communication standard. In the present embodiment, the vehicle 10 is connected to the network 40 via the communication interface 12. This enables the vehicle 10 to communicate with the server 20 or the like.

The memory 13 is, for example, a semiconductor memory, a magnetic memory, an optical memory, or the like. The memory 13 functions as, for example, a main memory, an auxiliary memory, or a cache memory. The memory 13 stores any information used for operations of the vehicle 10. For example, the memory 13 stores a system program, an application program, embedded software, or the like. The information stored in the memory 13 may be updated with, for example, information acquired from the network 40 via the communication interface 12.

The controller 14 includes at least one processor. The processor may be, for example, a general purpose processor such as a Central Processing Unit (CPU), or a dedicated processor that is dedicated to specific processing, or the like. The controller 14 is not limited to a processor and may include at least one dedicated circuit. Examples of the dedicated circuit may include a Field-Programmable Gate Array (FPGA) and an Application Specific Integrated Circuit (ASIC). The controller 14 controls the components such as the positioner 11, the communication interface 12, and the memory 13 that are described above in order to realize the functions of the communication apparatus 15, including the functions of the components.

The functions of the communication apparatus 15 are realized by executing a communication apparatus program according to the present embodiment on a processor of a computer. That is, the functions of the communication apparatus 15 are realized by software. The communication apparatus program is a program for causing the computer to execute the processing of steps included in operations of the communication apparatus 15, thereby enabling the computer to realize the function corresponding to the processing of the step. That is, the communication apparatus program is a program for causing the computer to function as the communication apparatus 15.

The program can be recorded on a non-transitory computer readable recording medium. The non-transitory computer readable recording medium is, for example, a magnetic recording device, an optical disc, a magneto-optical recording medium, or a semiconductor memory. The distribution of the program is performed by, for example, sale, transfer, or rental of a portable recording medium such as a digital versatile disc (DVD) or a compact disc read only memory (CD-ROM) on which the program is recorded. Alternatively, the program may be distributed by storing in a storage of a predetermined server and transferring the program from the predetermined server to another computer. The program may also be provided as a program product.

The computer temporarily stores, for example, a program recorded on a portable recording medium or a program transferred from a predetermined server, in a memory. Then, the computer reads the program stored in the memory using a processor, and executes processing in accordance with the read program using the processor. The computer may read a program directly from the portable recording medium, and execute processing in accordance with the program. Each time a program is transferred from the predetermined server to the computer, the computer may execute processing in accordance with the received program in order. The processing may be executed through a so-called application service provider (ASP)-type service which realizes functions merely by execution of instructions and acquisition of results, without transferring the program from the predetermined server to the computer. Programs encompass information that is to be used for processing by a computer and is thus equivalent to a program. For example, data that is not a direct command to a computer but has a property that regulates processing of the computer is “equivalent to a program” in this context.

(Configuration of Server)

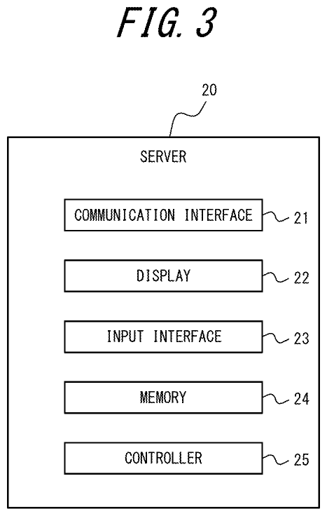

With reference to FIG. 3, a configuration of the server 20 according to the present embodiment will be described. FIG. 3 is a block diagram illustrating the configuration of the server 20. As illustrated in the block diagram of FIG. 3, the server 20 includes a communication interface 21, a display 22, an input interface 23, a memory 24, and a controller 25. The communication interface 21, the display 22, the input interface 23, the memory 24, and the controller 25 are connected so as to be able to communicate with one another by wire or wirelessly.

The communication interface 21 includes a communication module for connecting to the network 40. The communication module is, for example, a communication module compliant with a mobile communication standard such as the 4G standard or the 5G standard. The communication module may be, for example, a communication module compliant with a standard such as a wired LAN standard or a wireless LAN standard. The communication module may be a communication module compliant with a short-range wireless communication standard such as Wi-Fi®, Bluetooth®, or an infrared communication standard. In the present embodiment, the server 20 is connected to the network 40 via the communication interface 21. This enables the server 20 to communicate with the vehicle 10 and the terminal apparatus 30.

The display 22 displays information in the form of an image, text, or the like. The display 22 includes, for example, a display device such as a monitor.

The input interface 23 accepts input operations. The input interface 23 includes, for example, an input device such as a touch panel, a physical key, a camera, a microphone, or an IC card reader.

The memory 24 is, for example, a semiconductor memory, a magnetic memory, an optical memory, or the like. The memory 24 functions as, for example, a main memory, an auxiliary memory, or a cache memory. The memory 24 stores any information used for operations of the server 20. For example, the memory 24 stores a system program, an application program, embedded software, a database, or the like. The information stored in the memory 24 may be updated with, for example, information acquired from the network 40 via the communication interface 21.

The memory 24 stores, for example, association information associating one or more positions with states of respective radio waves received at the one or more positions. The state of a radio wave includes, for example, time series change in the intensity of the radio wave. Time series change in the intensity of a radio wave refers to increases or decreases in the intensity of the radio wave caused by the movement of the vehicle 10, where the radio wave wirelessly received by the vehicle 10 is attenuated by being blocked by a shielding object, or stop being attenuated when the radio wave is no longer blocked by the shielding object. Such increases or decreases in the intensity of the radio wave renders different features depending on the position, material, or shape of the shielding object. Therefore, the state of a radio wave has different features per position, and thus is also referred to as a fingerprint. However, the state of a radio wave is not limited to the intensity of the radio wave, and may include a waveform or a frequency of the radio wave, and may be represented by such values as an average value or a representative value, rather than by the time series change. For example, the state of a radio wave may include the number or interval of disruptions of the radio wave received during a predetermined period. The association information may be generated through, for example, machine learning or the like, based on information collected from at least one vehicle 10, the information indicating the state of a radio wave received by the vehicle 10 in the past and the position of the vehicle 10 when the radio wave was received. The association information may be generated based on information collected from a plurality of the vehicles 10, or may be generated based on information collected from one of the vehicles 10.

The controller 25 includes at least one processor. The processor may be, for example, a general purpose processor such as a CPU, a dedicated processor that is dedicated to specific processing, or the like. The controller 25 is not limited to a processor and may include at least one dedicated circuit. Examples of the dedicated circuits may include an FPGA and an ASIC. The controller 25 controls the components such as the communication interface 21, the display 22, the input interface 23, and the memory 24 that are described above in order to realize the functions of the server 20 including the functions of the components.

The functions of the server 20 are realized by executing a control program according to the present embodiment on a processor of a computer. That is, the functions of the server 20 are realized by software. The control program is a program for causing a computer to execute the processing of steps included in operations of the server 20, thereby enabling the computer to realize the functions corresponding to the processing of the steps. That is, the control program is a program for causing the computer to function as the server 20.

(Operations of Information Processing System)

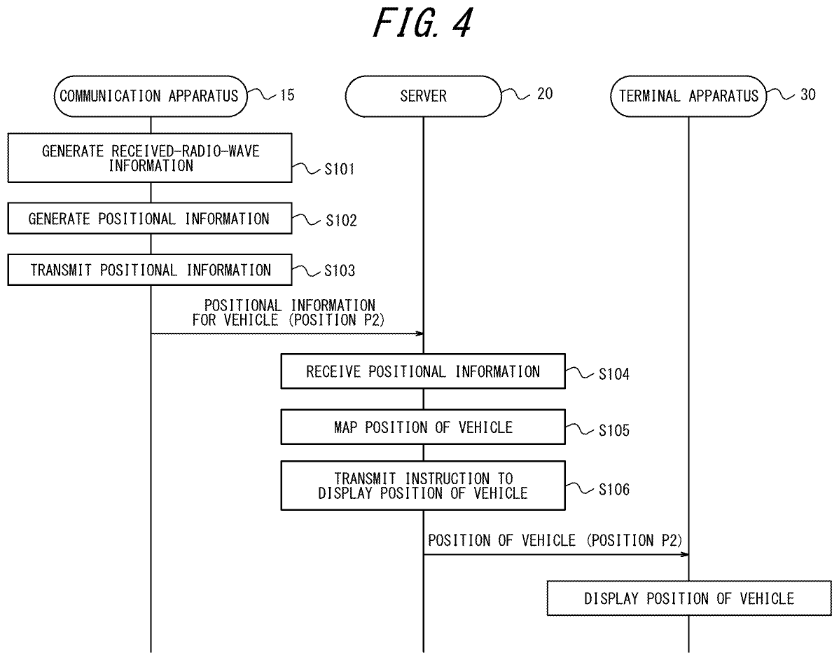

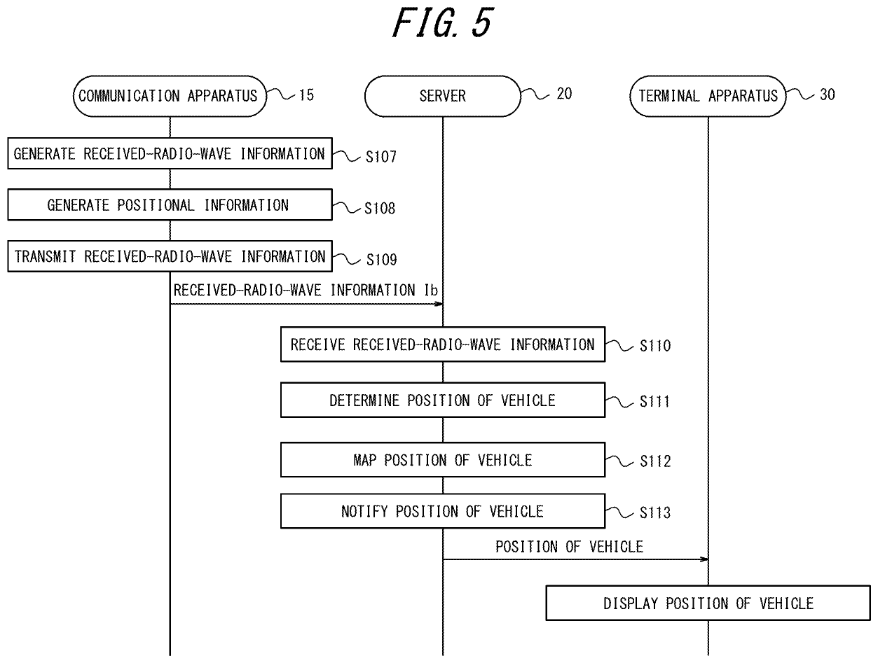

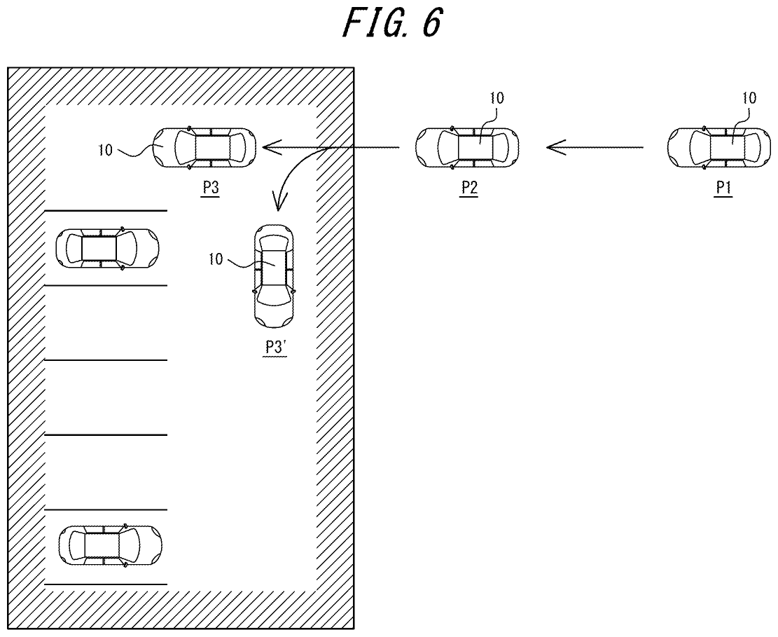

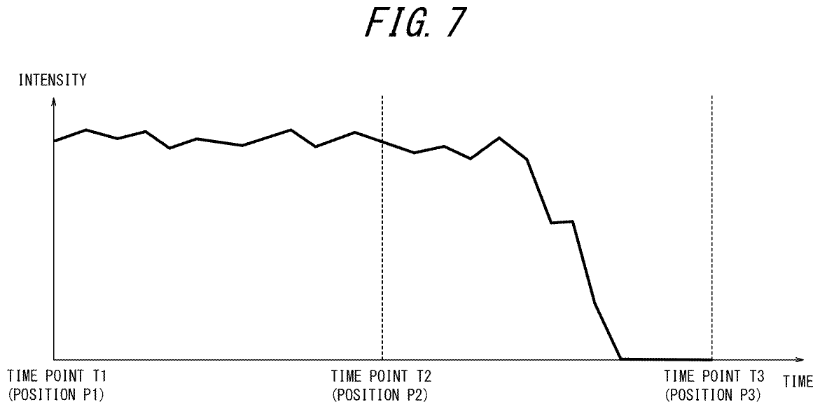

With reference to FIGS. 4, 5, 6, and 7, operations of the information processing system 1 will be described. FIG. 4 is a flowchart illustrating the operations of the information processing system 1. FIG. 5 is a flowchart illustrating the operations of the information processing system 1, following those of FIG. 4. FIG. 6 is a schematic diagram illustrating positions of the vehicle 10 in one example. FIG. 7 illustrates time series change in the intensity of a radio wave received by the vehicle 10 illustrated in FIG. 6. In the explanation of the operations, the communication apparatus 15 is assumed as included in the vehicle 10. Therefore, the operations of the communication apparatus 15 can also be deemed as operations of the vehicle 10 that includes the communication apparatus 15. In the explanation of the operations, the server 20 is assumed as storing, in the memory 24 in advance, association information associating one or more positions with states of respective radio waves received at the one or more positions.

In the explanation of the operations, the vehicle 10 is assumed to move from the position P1 to the position P3 via the position P2, as illustrated in FIG. 6. In FIG. 6, the hatched area indicates an area where a radio wave to be wirelessly received from outside by the vehicle 10 is attenuated. Hereinafter, the area where a radio wave to be wirelessly received from outside by the vehicle 10 is attenuated may also be referred to as “attenuation area”. The attenuation area is, for example, an underground parking lot.

First, with reference to FIG. 4, operations of the information processing system 1 to be performed when the vehicle 10 moves from the position P1 to the position P2 in FIG. 6 will be described.

As illustrated in FIG. 4, in Step S101, the communication apparatus 15 wirelessly receives a radio wave and generates received-radio-wave information indicating the state of the radio wave received.

In the present embodiment, the radio wave wirelessly received by the communication apparatus 15 is assumed to be received from an artificial satellite for navigation using a satellite positioning system. Therefore, the controller 14 of the communication apparatus 15 receives a radio wave from an artificial satellite via the positioner 11, for navigation using a satellite positioning system. The controller 14 generates received-radio-wave information indicating the state of a radio wave wirelessly received. In the present embodiment, the controller 14 generates, as the received-radio-wave information, information indicating the state of any one of radio waves respectively received from the three artificial satellites. However, the controller 14 may generate, as the received-radio-wave information, information indicating the states of a plurality of radio waves. In the present embodiment, the state of a radio wave includes time series change in the intensity of the radio wave in a predetermined period such as T seconds immediately before generating the received-radio-wave information. However, the state of a radio wave may include the number of times or interval of disruptions of the radio wave received during a predetermined period as described above. The controller 14 stores the generated received-radio-wave information, in the memory 13.

In the example illustrated in FIG. 6, the controller 14 of the communication apparatus 15 continuously receives a radio wave wirelessly from an artificial satellite via the positioner 11, during when the vehicle 10 that includes the communication apparatus 15 moves from the position P1 to the position P2. In this example, the controller 14 continuously receives a radio wave from an artificial satellite, but may intermittently receive the radio wave. The vehicle 10 can move from the position P1 to the position P2 without entering the attenuation area, and thus the vehicle 10 can stably receive a radio wave. For example, as illustrated in FIG. 7, a radio wave wirelessly received by the positioner 11 renders time series change in the intensity from a time point T1, at which the vehicle 10 leaves the position P1, to a time point T2, at which the vehicle 10 arrives at the position P2. In such a case, at the position P2, the controller 14 generates received-radio-wave information Ia that indicates, as the state of a radio wave wirelessly received via the positioner 11 while the vehicle 10 moves from the position P1 to the position P2, the time series change in the intensity of the radio wave from the time point T1 to the time point T2.

With reference again to FIG. 4, in Step S102, the controller 14 of the communication apparatus 15 controls the positioner 11 to generate positional information for the vehicle 10 through navigation using a satellite positioning system. The controller 14 stores the generated positional information for the vehicle 10, in the memory 13.

In Step S103, the controller 14 of the communication apparatus 15 transmits the positional information for the vehicle 10 to the server 20 via the communication interface 12, in a case in which the positional information for the vehicle 10 was generated.

In the example illustrated in FIG. 6, the vehicle 10 at the position P2 is not located in the attenuation area illustrated as the hatched area. Therefore, the controller 14 of the communication apparatus 15 can generate positional information for the vehicle 10 by measuring the position P2 of the vehicle 10 via the positioner 11 through navigation using a satellite positioning system. The positional information for the vehicle 10 includes the coordinates of the position P2 of the vehicle 10 at the time point T2. The controller 14 transmits the generated positional information for the vehicle 10 to the server 20 via the communication interface 12.

With reference again to FIG. 4, in Step S104, the controller 25 of the server 20 receives, from the vehicle 10 via the communication interface 21, positional information for the vehicle 10. The controller 25 stores the received positional information for the vehicle 10, in the memory 24.

In Step S105, the controller 25 of the server 20 maps the position of the vehicle 10 on a map.

Specifically, the controller 25 of the server 20 determines the position of the vehicle 10, based on the positional information for the vehicle 10 received from the vehicle 10. The controller 25 starts an application such as a Geographic Information System (GIS) and maps the position of the vehicle 10 on the map. The controller 25 may display, via the display 22, the position of the vehicle 10 mapped on the map.

In Step S106, the controller 25 of the server 20 transmits, via the communication interface 21, an instruction to display the position of the vehicle 10 to the terminal apparatus 30 used by a user of the vehicle 10. The instruction to display the position of the vehicle 10 includes, for example, information on the map to be displayed and coordinates indicating the position of the vehicle 10 mapped on the map. Thus, the terminal apparatus 30 can display the position of the vehicle 10 on the map, on a display.

In the example illustrated in FIG. 6, the server 20 determines that the vehicle 10 is located at the position P2, based on the positional information received from the vehicle 10. The server 20 maps the position P2 of the vehicle 10 on a map via the display 22, and transmits an instruction to display the position P2 of the vehicle 10 to the terminal apparatus 30 used by a user of the vehicle 10. Thus, the terminal apparatus 30 can display the position P2 of the vehicle 10 on a map on a display of the terminal apparatus 30.

Next, with reference to FIG. 5, operations of the information processing system 1 to be performed when the vehicle 10 moves from the position P2 to the position P3 in FIG. 6 will be described.

As illustrated in FIG. 5, in Step S107, the communication apparatus 15 wirelessly receives a radio wave and generates received-radio-wave information indicating the state of the radio wave received, in the same manner as in Step S101. Specifically, the controller 14 of the communication apparatus 15 receives a radio wave from an artificial satellite via the positioner 11, for navigation using a satellite positioning system.

In the example illustrated in FIG. 6, the controller 14 of the communication apparatus 15 continuously receives, via the positioner 11, a radio wave wirelessly received while the vehicle 10 that includes the communication apparatus 15 moves from the position P2 to the position P3. At this time, the vehicle 10 enters the attenuation area in the course of moving from the position P2 to the position P3, and a radio wave to be received is attenuated. For example, as illustrated in FIG. 7, a radio wave wirelessly received by the positioner 11 renders time series change in the intensity from a time point T2, at which the vehicle 10 leaves the position P2, to a time point T3, at which the vehicle 10 arrives at the position P3. In FIG. 7, the radio wave is attenuated from the time point T2 toward the time point T3, and is disrupted before the vehicle 10 reaches the position P3. In such a case, the controller 14 generates, at the position P3, the received-radio-wave information Ib, as the state of the radio wave wirelessly received via the positioner 11 while the vehicle 10 moves from the position P2 to the position P3, the received-radio-wave information Ib including the time series change in the intensity of the radio wave from the time point T2 to the time point T3.

With reference again to FIG. 5, in Step S108, the controller 14 of the communication apparatus 15 controls the positioner 11 and attempts to generate the positional information for the vehicle 10, in the same manner as in Step S102.

However, in the example illustrated in FIG. 6, the vehicle 10 at the position P3 is located in the attenuation area illustrated as the hatched area. Therefore, the controller 14 of the communication apparatus 15 cannot measure the position of the vehicle 10 through navigation using a satellite positioning system via the positioner 11, and thus cannot generate the positional information for the vehicle 10.

In Step S109, in a case in which the positioner 11 has failed to generate the positional information for the vehicle 10, the controller 14 of the communication apparatus 15 transmits the received-radio-wave information Ib to the server 20 via the communication interface 12.

In the example illustrated in FIG. 6, the controller 14 of the communication apparatus 15 cannot generate positional information for the vehicle 10, at the position P3. Therefore, the controller 14 transmits, to the server 20 via the communication interface 12, the received-radio-wave information Ib indicating the state of the radio wave wirelessly received while the vehicle 10 moves from the position P2 to the position P3.

With reference again to FIG. 5, in Step S110, the controller 25 of the server 20 receives the received-radio-wave information Ib, from the vehicle 10 via the communication interface 21. The controller 25 may receive the received-radio-wave information Ib from the vehicle 10 in a case in which the controller 25 has failed to receive, from the vehicle 10 via the communication interface 21, the positional information for the vehicle 10. The controller 25 stores the received-radio-wave information Ib in the memory 24.

In Step S111, the controller 25 of the server 20 determines the position of the vehicle 10 based on the received-radio-wave information Ib using association information associating one or more positions with states of respective radio waves received at the one or more positions.

Specifically, the controller 25 of the server 20 compares the time series change in the intensity of the radio wave indicated by the received-radio-wave information Ib with the time series change in the intensity of the radio wave indicated as the state of the radio wave by the association information, and determines whether the states of the two radio waves are identical or similar to each other. For example, the controller 25 calculates a correlation coefficient between the time series change in the intensity of the radio wave indicated by the received-radio-wave information Ib, and the time series change in the intensity of the radio wave indicated by the association information. If the correlation coefficient for the two radio waves is equal to or larger than a predetermined threshold, the controller 25 determines that the two radio waves are in identical or similar states. When the association information is determined as indicating the state of the radio wave identical or similar to the state of the radio wave indicated by the received-radio-wave information Ib, the controller 25 determines the position associated with the state of the radio wave, as the position of the vehicle 10.

In the example illustrated in FIG. 6, a state W1 of the radio wave received by the vehicle 10 that has entered the underground parking lot from the position P2 in the past and then traveled straight toward the position P3 is assumed as being associated with the position P3 in the association information stored in the memory 24 of the server 20. The controller 25 of the server 20 determines that the association information indicates the state W1 of the radio wave identical or similar to the state of the radio wave indicated by the received-radio-wave information Ib received from the vehicle 10. Thus, the controller 25 determines the position P3 as the position of the vehicle 10.

Further, the controller 25 of the server 20 may determine the traveling direction of the vehicle 10 based on the received-radio-wave information Ib, using association information associating one or more positions with states of respective radio waves received at the one or more positions.

In the example illustrated in FIG. 6, the association information is assumed to associate, in addition to the state W1 of the radio wave, a state W2 of the radio wave received by the vehicle 10 that has turned left toward the position P3′ after entering the underground parking lot from the position P2 in the past, with the position P3′. Thus, the controller 25 of the server 20 compares the received-radio-wave information Ib received from the vehicle 10 with the states W1 and W2 of the radio waves indicated by the association information, to determine whether the vehicle 10 traveled straight or turned left after entering the underground parking lot.

In Step S112, the controller 25 of the server 20 maps the position of the vehicle 10 on a map, in the same manner as in Step S105.

Specifically, the controller 25 of the server 20 starts an application such as a GIS, and maps the position of the vehicle 10 determined based on the received-radio-wave information Ib, on the map. The controller 25 may display, via the display 22, the position of the vehicle 10 mapped on the map.

In Step S113, the controller 25 of the server 20 transmits, via the communication interface 21, an instruction to display the position of the vehicle 10, to the terminal apparatus 30 used by a user of the vehicle 10, in the same manner as in Step S106. The instruction to display the position of the vehicle 10 includes, for example, information on a map to be displayed and coordinates indicating the position of the vehicle 10 mapped on the map. Thus, the terminal apparatus 30 can display the position of the vehicle 10 on a map, on a display.

In the example illustrated in FIG. 6, the server 20 determines, based on the received-radio-wave information Ib received from the vehicle 10, that the vehicle 10 is located at the position P3. The server 20 maps the position P3 of the vehicle 10 on a map via the display 22, and transmits an instruction to display the position P3 of the vehicle 10, to the terminal apparatus 30 used by a user of the vehicle 10. Thus, the terminal apparatus 30 can display the position P3 of the vehicle 10 on a map on the display of the terminal apparatus 30.

As described above, the server 20 according to the present embodiment includes a communication interface 21, and a controller 25 configured to receive, from a vehicle 10 via the communication interface 21, received-radio-wave information indicating a state of a radio wave wirelessly received by the vehicle 10 and determine a position of the vehicle 10 based on the received-radio-wave information using association information associating one or more positions with states of respective radio waves received at the one or more positions. This configuration enables the server 20 to determine the position of the vehicle 10 in a remote location, based on information received from the vehicle 10. Accordingly, the server 20 can improve the utility of technology for determining the position of the vehicle 10. Further, the server 20 performs the processing of determining the position of the vehicle 10, which can reduce the processing load on the vehicle 10 side as compared with a case in which the same processing is performed on the vehicle 10 side.

In the server 20 according to the present embodiment, the state of a radio wave may include time series change in intensity of the radio wave. By using the time series change in the intensity of the radio wave, the server 20 can readily determine the difference in features that varies depending on the position, material, or shape of the shielding object, for each position where the radio wave was received. Therefore, the server 20 can determine the position of the vehicle 10 with further improved accuracy.

In the server 20 according to the present embodiment, the controller 25 can determine the position of the vehicle 10 based on the received-radio-wave information, in a case in which the controller 25 has failed to receive, from the vehicle 10 via the communication interface 21, the positional information for the vehicle 10. This configuration enables the server 20 to determine the position of the vehicle 10 based on information received from the vehicle 10, in a case in which the controller 25 has failed to receive the positional information for the vehicle 10 from the vehicle 10. Accordingly, the server 20 may further improve the utility of technology for determining the position of the vehicle 10.

In the server 20 according to the present embodiment, the vehicle 10 may generate positional information for the vehicle 10 through navigation using a satellite positioning system, and the radio wave may be a radio wave received by the vehicle 10 from an artificial satellite for navigation using a satellite positioning system. This configuration can utilize a function, such as a car navigation apparatus, which is generally provided to the vehicle 10 for generating positional information for the vehicle 10, and thus can enable the server 20 to determine the position of the vehicle 10, without requiring major feature additions to the vehicle 10.

In the server 20 according to the present embodiment, the controller 25 can determine the travel direction of the vehicle 10 based on the received-radio-wave information using the association information. This configuration enables the server 20 to further improve the utility of technology for determining the position of the vehicle 10.

In the server 20 according to the present embodiment, the controller 25 can map the position of the vehicle 10 on a map. This configuration enables the server 20 to present the position of the vehicle 10 in a more easy-to-understand manner.

In the server 20 according to the present embodiment, the controller 25 can transmit, via the communication interface 21, an instruction to display the position of the vehicle 10 to the terminal apparatus 30 used by a user of the vehicle 10. This configuration enables the server 20 to present the position of the vehicle 10 to the user of the vehicle 10 in a more easy-to-understand manner.

The communication apparatus 15 according to the present embodiment is a communication apparatus 15 included in a vehicle 10, the communication apparatus 15 including a communication interface 12, and a controller 14 configured to transmit, to a server 20 via the communication interface 12, received-radio-wave information indicating a state of a radio wave wirelessly received by the vehicle 10, and cause the server 20 to determine the position of the vehicle 10 based on the received-radio-wave information using association information associating one or more positions with states of respective radio waves received at the one or more positions. This configuration enables the communication apparatus 15 to cause the server 20 to determine the position of the vehicle 10 based on information received from the vehicle 10. Accordingly, the communication apparatus 15 can improve the utility of technology for determining the position of the vehicle 10.

In the communication apparatus 15 according to the present embodiment, the state of a radio wave may include time series change in intensity of the radio wave. This configuration enables the server 20 to determine the position of the vehicle 10 with improved accuracy.

In the communication apparatus 15 according to the present embodiment, the controller 14 transmits, to the server 20 via the communication interface 12, the positional information for the vehicle 10, and the server 20 can determine the position of the vehicle 10 based on the received-radio-wave information in a case in which the server 20 has failed to receive the positional information for the vehicle 10 from the vehicle 10. This configuration enables the communication apparatus 15 to cause the server 20 to determine the position of the vehicle 10 based on information received from the vehicle 10 only in a case in which the server 20 has failed to receive the positional information for the vehicle 10 from the vehicle 10. Therefore, the communication apparatus 15 can reduce the processing load on the server 20 arising from the processing for determining the position of the vehicle 10 based on the received-radio-wave information.

In the communication apparatus 15 according to the present embodiment, the communication apparatus 15 includes the positioner 11 for measuring a position of the vehicle 10 through navigation using a satellite positioning system, the controller 14 controls the positioner 11 to generate positional information for the vehicle 10, and the radio wave is a radio wave received by the positioner 11 from an artificial satellite for navigation using the satellite positioning system. This configuration enables the communication apparatus 15 to generate information for causing the server 20 to determine the position of the vehicle 10 by utilizing a function generally provided in the positioner 11 for generating positional information for the vehicle 10.

In the communication apparatus 15 according to the present embodiment, in a case in which the positioner 11 has failed to generate the positional information for the vehicle 10, the controller 14 can transmit the received-radio-wave information to the server 20 via the communication interface 12. This configuration can reduce the number of times the communication apparatus 15 transmits the received-radio-wave information to the server 20, and thus the processing load on the communication apparatus 15 can be reduced.

While the present disclosure has been described with reference to the drawings and examples, it should be noted that various modifications and revisions can be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

For example, the embodiment described above has been explained based on that the communication apparatus 15 transmits the received-radio-wave information to the server 20 in a case in which the communication apparatus 15 has failed to generate the positional information for the vehicle 10 through navigation using a satellite positioning system. However, the communication apparatus 15 may repeatedly transmit the received-radio-wave information indicating the state of the radio wave wirelessly received by the vehicle 10, without generating positional information for the vehicle 10 through navigation using a satellite positioning system. The radio wave to be wirelessly received are not limited to a radio wave received from an artificial satellite via the positioner 11, and may be any other radio wave received via the communication interface 12. This configuration enables the server 20 to determine the position of the vehicle 10, even in a case in which the communication apparatus 15 of the vehicle 10 does not include the positioner 11.

Further, for example, in the embodiment described above, all or part of the function or processing described as the functions or processing of the server 20 may be realized as the functions or processing of the communication apparatus 15 of the vehicle 10. Specifically, a program in which processes for realizing the functions of the server 20 according to the embodiment are written may be stored in a memory of the communication apparatus 15 or the like, and the program may be read and executed by a processor of the communication apparatus 15 or the like.

With this configuration, the communication apparatus 15 of the vehicle 10 can determine the position of the vehicle 10 based on received-radio-wave information indicating the state of a radio wave wirelessly received by the vehicle 10, in a case in which the positioner 11 cannot measure the position of the vehicle 10 through navigation using a satellite positioning system.

In addition, a general purpose computer such as, for example, a smartphone may be configured to function as the communication apparatus 15 or the server 20 according to the embodiment described above. Specifically, a program in which processes for realizing the functions of the communication apparatus 15 or the server 20 according to the embodiment are written may be stored in a memory of a computer, and the program may be read and executed by a processor of the computer. For example, when a general purpose computer is caused to function as the communication apparatus 15 of the vehicle 10, a computer having the configuration and functions of the communication apparatus 15 of the vehicle 10 described above may be installed on the vehicle 10.

1. A server comprising:
a communication interface; and
a controller configured to receive, from a vehicle via the communication interface, received-radio-wave information indicating a state of a radio wave wirelessly received by the vehicle, and determine a position of the vehicle based on the received-radio-wave information using association information associating one or more positions with states of respective radio waves received at the one or more positions.

2. The server according to claim 1, wherein the state of the radio wave includes time series change in intensity of the radio wave.

3. The server according to claim 1, wherein the controller is configured to determine the position of the vehicle based on the received-radio-wave information, in a case in which the controller has failed to receive, from the vehicle via the communication interface, positional information for the vehicle.

4. The server according to claim 3, wherein
the vehicle is configured to generate the positional information for the vehicle through navigation using a satellite positioning system, and
the radio wave includes a radio wave received by the vehicle from an artificial satellite for navigation using the satellite positioning system.

5. The server according to claim 1, wherein the controller is configured to determine a travel direction of the vehicle based on the received-radio-wave information using the association information.

6. The server according to claim 1, wherein the controller is configured to map the position of the vehicle on a map.

7. The server according to claim 1, wherein the controller is configured to transmit, via the communication interface to a terminal apparatus used by a user of the vehicle, an instruction to display the position of the vehicle.

8. A non-transitory computer readable medium storing a program configured to cause a computer to function as a server, the server comprising:
a communication interface; and
a controller configured to receive, from a vehicle via the communication interface, received-radio-wave information indicating a state of a radio wave wirelessly received by the vehicle, and determine a position of the vehicle based on the received-radio-wave information using association information associating one or more positions with states of respective radio waves received at the one or more positions.

9. The non-transitory computer readable medium according to claim 8, wherein the state of the radio wave includes time series change in intensity of the radio wave.

10. The non-transitory computer readable medium according to claim 8, wherein the server is configured to determine the position of the vehicle based on the received-radio-wave information, in a case in which the server has failed to receive, from the vehicle via the communication interface, positional information for the vehicle.

11. The non-transitory computer readable medium according to claim 10, wherein
the vehicle is configured to generate the positional information for the vehicle through navigation using a satellite positioning system, and
the radio wave includes a radio wave received by the vehicle from an artificial satellite for navigation using the satellite positioning system.

12. The non-transitory computer readable medium according to claim 8, wherein the server is configured to determine a travel direction of the vehicle based on the received-radio-wave information using the association information.

13. The non-transitory computer readable medium according to claim 8, wherein the server is configured to map the position of the vehicle on a map.

14. The non-transitory computer readable medium according to claim 8, wherein the server is configured to transmit, via the communication interface to a terminal apparatus used by a user of the vehicle, an instruction to display the position of the vehicle.

15. A communication apparatus included in a vehicle, the communication apparatus comprising:
a communication interface; and
a controller configured to transmit, to a server via the communication interface, received-radio-wave information indicating a state of a radio wave wirelessly received by the vehicle, and cause the server to determine a position of the vehicle based on the received-radio-wave information using association information associating one or more positions with states of respective radio waves received at the one or more positions.

16. The communication apparatus according to claim 15, wherein the state of the radio wave includes time series change in intensity of the radio wave.

17. The communication apparatus according to claim 15, wherein
the controller is configured to transmit, to the server via the communication interface, positional information for the vehicle, and
the server is configured to determine the position of the vehicle based on the received-radio-wave information, in a case in which the server has failed to receive the positional information for the vehicle from the vehicle.

18. The communication apparatus according to claim 17, wherein
the communication apparatus includes a positioner configured to measure the position of the vehicle through navigation using a satellite positioning system,
the controller is configured to control the positioner to generate the positional information for the vehicle, and
the radio wave includes a radio wave received by the positioner from an artificial satellite for navigation using the satellite positioning system.

19. The communication apparatus according to claim 18, wherein the controller is configured to transmit the received-radio-wave information to the server via the communication interface, in a case in which the positioner has failed to generate the positional information for the vehicle.

20. A vehicle comprising the communication interface according to claim 15.
